(19) United States
(12) Patent Application Publication
(10) Pub. No.: US 2025/0308365 A1
(43) Pub. Date: Oct. 2, 2025

(54) PERFORMANCE MONITORING SYSTEM WITH CONTEXT-AWARE DYNAMIC THRESHOLD SETTING

(71) Applicant: Lenovo Enterprise Solutions (Singapore) Pte. Ltd., New Tech Park (SG)

(72) Inventors: Fred Allison Bower, III, Durham, NC (US); Constantin Cristian Ghioc, Bucharest (RO); Liviu Muresanu, Bucharest (RO); Ioan-Tudor-Alexandru Anghel, Bucharest (RO); Andrei Paun, Bucharest (RO); Athanasia Popa, Bucuresti (RO); Vlad-Gabriel Dumitru, Ploiesti (RO)

(21) Appl. No.: 18/619,860

(22) Filed: Mar. 28, 2024

(51) Int. Cl. G08B 21/18; G06F 8/60

(52) U.S. Cl. CPC G08B 21/182; G06F 8/60

(57) ABSTRACT

A method for performance monitoring with context-aware dynamic threshold setting includes determining initiation of a deployment operation for a computing device. The deployment operation differs from operations that include processing, on the computing device, workloads for one or more clients. The method includes receiving one or more deployment thresholds associated with the deployment operation, implementing the one or more deployment thresholds, adjusting one or more operational thresholds conflicting with the deployment operation, and transmitting an alert in response to detection of a metric associated with a deployment threshold of the one or more deployment thresholds exceeding the deployment threshold.

### FIELD

The subject matter disclosed herein relates to dynamic thresholds and more particularly relates to performance monitoring with context-aware dynamic threshold setting.

### BACKGROUND

Middleware running on monitoring servers typically include thresholds where a metric crossing a threshold triggers sending an alert to a user interface. Dynamic thresholds are able to vary over time. However, some events such as deployment operations to install software, update an application, or the like cause abrupt transitions to a very different operating environment where current thresholds may not be applicable.

### BRIEF SUMMARY

A method for performance monitoring with context-aware dynamic threshold setting is disclosed. An apparatus and computer program product also perform the functions of the method. The method includes determining initiation of a deployment operation for a computing device. The deployment operation differs from operations that include processing, on the computing device, workloads for one or more clients. The method includes receiving one or more deployment thresholds associated with the deployment operation, implementing the one or more deployment thresholds, adjusting one or more operational thresholds conflicting with the deployment operation, and transmitting an alert in response to detection of a metric associated with a deployment threshold of the one or more deployment thresholds exceeding the deployment threshold.

An apparatus for performance monitoring with context-aware dynamic threshold setting includes a processor and non-transitory computer readable storage media storing code. The code is executable by the processor to perform operations that include determining initiation of a deployment operation for a computing device. The deployment operation differs from operations that include processing, on the computing device, workloads for one or more clients. The operations include receiving one or more deployment thresholds associated with the deployment operation, implementing the one or more deployment thresholds, adjusting one or more operational thresholds conflicting with the deployment operation, and transmitting an alert in response to detection of a metric associated with a deployment threshold of the one or more deployment thresholds exceeding the deployment threshold.

A program product for performance monitoring with context-aware dynamic threshold setting includes a non-transitory computer readable storage medium storing code. The code is configured to be executable by a processor to perform operations that include determining initiation of a deployment operation for a computing device. The deployment operation differs from operations that include processing, on the computing device, workloads for one or more clients. The operations include receiving one or more deployment thresholds associated with the deployment operation, implementing the one or more deployment thresholds, adjusting one or more operational thresholds conflicting with the deployment operation, and transmitting an alert in response to detection of a metric associated with a deployment threshold of the one or more deployment thresholds exceeding the deployment threshold.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for performance monitoring with context-aware dynamic threshold setting, according to various embodiments;

FIG. 2 is a schematic block diagram illustrating interaction between a backend, middleware and a user interface for performance monitoring with context-aware dynamic threshold setting, according to various embodiments;

FIG. 3 is a schematic block diagram illustrating an apparatus for performance monitoring with context-aware dynamic threshold setting, according to various embodiments;

FIG. 4 is a schematic block diagram illustrating another apparatus for performance monitoring with context-aware dynamic threshold setting, according to various embodiments;

FIG. 5 is a schematic flow chart diagram illustrating a method for performance monitoring with context-aware dynamic threshold setting, according to various embodiments; and

FIG. 6 is a schematic flow chart diagram illustrating another method for performance monitoring with context-aware dynamic threshold setting, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for performance monitoring with context-aware dynamic threshold setting is disclosed. An apparatus and computer program product also perform the functions of the method. The method includes determining initiation of a deployment operation for a computing device. The deployment operation differs from operations that include processing, on the computing device, workloads for one or more clients. The method includes receiving one or more deployment thresholds associated with the deployment operation, implementing the one or more deployment thresholds, adjusting one or more operational thresholds conflicting with the deployment operation, and transmitting an alert in response to detection of a metric associated with a deployment threshold of the one or more deployment thresholds exceeding the deployment threshold.

In some embodiments, the method includes determining that the deployment operation has concluded, deactivating the one or more deployment thresholds in response to the deployment operation being concluded, and resetting the one or more operational thresholds altered during the deployment operation. In other embodiments, determining that the deployment operation has concluded includes detecting that the deployment operation has concluded or receiving a notification that the deployment operation has concluded. In other embodiments, the deployment operation is initiated through a management network separate from a computer network servicing execution of the workloads for the one or more clients. In other embodiments, the alert is transmitted to a user interface of a datacenter monitoring system and/or a management server connected to a management network.

In some embodiments, the deployment operation is initiated via a management network. In other embodiments, the deployment operation interrupts processing of the workloads for the one or more clients on the computing device. In other embodiments, determining the initiation of the deployment operation for the computing device includes detecting the initiation of the deployment operation or receiving a notification of the initiation of the deployment operation. In other embodiments, the deployment operation includes an operation to install, update, configure, commission, and/or remove an operating system, an application, and/or firmware.

An apparatus for performance monitoring with context-aware dynamic threshold setting includes a processor and non-transitory computer readable storage media storing code. The code is executable by the processor to perform operations that include determining initiation of a deployment operation for a computing device. The deployment operation differs from operations that include processing, on the computing device, workloads for one or more clients. The operations include receiving one or more deployment thresholds associated with the deployment operation, implementing the one or more deployment thresholds, adjusting one or more operational thresholds conflicting with the deployment operation, and transmitting an alert in response to detection of a metric associated with a deployment threshold of the one or more deployment thresholds exceeding the deployment threshold.

In some embodiments, the operations include determining that the deployment operation has concluded, deactivating the one or more deployment thresholds in response to the deployment operation being concluded, and resetting the one or more operational thresholds altered during the deployment operation. In other embodiments, determining that the deployment operation has concluded includes detecting that the deployment operation has concluded or receiving a notification that the deployment operation has concluded. In other embodiments, the deployment operation is initiated through a management network separate from a computer network servicing execution of the workloads for the one or more clients.

In some embodiments, the alert is transmitted to a user interface of a datacenter monitoring system and/or a management server connected to a management network. In other embodiments, the deployment operation is initiated via a management network. In other embodiments, the deployment operation interrupts processing of the workloads for the one or more clients on the computing device. In other embodiments, determining the initiation of the deployment operation for the computing device includes detecting the initiation of the deployment operation or receiving a notification of the initiation of the deployment operation. In other embodiments, the deployment operation includes an operation to install, update, configure, commission, and/or remove an operating system, an application, and/or firmware.

A program product for performance monitoring with context-aware dynamic threshold setting includes a non-transitory computer readable storage medium storing code. The code is configured to be executable by a processor to perform operations that include determining initiation of a deployment operation for a computing device. The deployment operation differs from operations that include processing, on the computing device, workloads for one or more clients. The operations include receiving one or more deployment thresholds associated with the deployment operation, implementing the one or more deployment thresholds, adjusting one or more operational thresholds conflicting with the deployment operation, and transmitting an alert in response to detection of a metric associated with a deployment threshold of the one or more deployment thresholds exceeding the deployment threshold.

In some embodiments, the operations include determining that the deployment operation has concluded, deactivating the one or more deployment thresholds in response to the deployment operation being concluded, and resetting the one or more operational thresholds altered during the deployment operation.

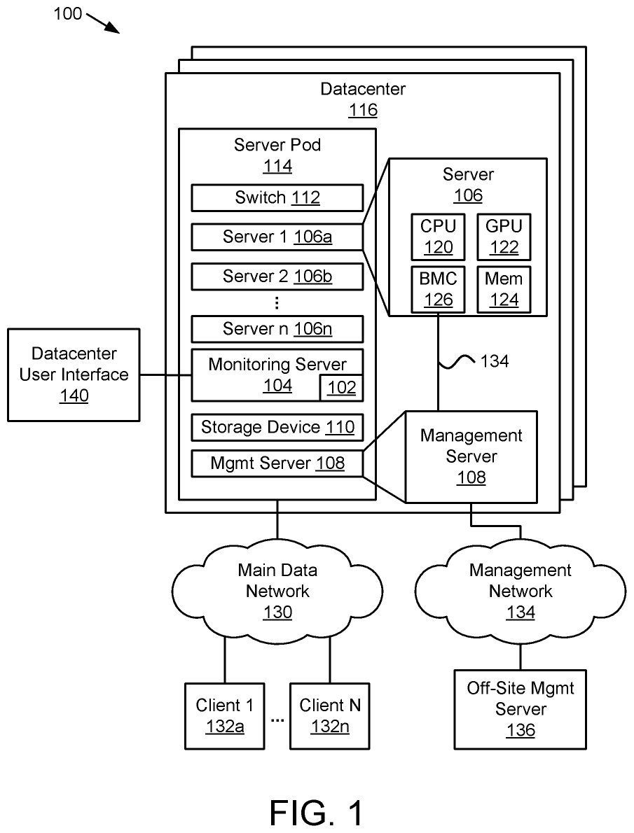

FIG. 1 is a schematic block diagram illustrating a system 100 for performance monitoring with context-aware dynamic threshold setting, according to various embodiments. The system 100 includes a deployment threshold apparatus 102 in a monitoring server 104, other servers 106a-106n (collectively or generally “106”), a management server 108, a storage device 110, and a switch 112, all in a server pod 114 of a datacenter 116. A server 106, in various embodiments, includes a central processing unit (“CPU”) 120, a graphics processing unit (“GPU”) 122, memory 124, and a baseboard management controller (“BMC”) 126, a main data network 130 and clients 132a-132n (collectively or generally “132”), a management network 134 and an off-site management server 136, and a datacenter user interface 140, which are described below.

During deployment operations, such as installation of an operating system or application, updating software, configuring an application, removing an application, or the like, typical operating thresholds may be exceeded or may not be applicable. Dynamic thresholds adjust over time, but when there is an abrupt transition to a deployment operation, dynamic thresholds often are inadequate so that operational thresholds are often manually suspended. A start of a deployment operation is typically abrupt and has very different operating requirements than typical processing of workloads.

The deployment threshold apparatus 102 determines when there is initiation of a deployment operation and receives deployment thresholds that are associated with the deployment operation. The deployment threshold apparatus 102, in some embodiments, implements the deployment thresholds and/or adjusts, suspends, etc. one or more operational thresholds conflicting with the deployment operation. When a parameter or metric exceeds a deployment threshold, the deployment threshold apparatus 102 transmits an alert. In some embodiments, the deployment threshold apparatus 102 determines when the deployment operation has concluded, deactivates the deployment thresholds, and reactivates, reinstates, resets, etc. any operations thresholds altered during the deployment operation.

The system 100 includes a monitoring server 104, servers 106a-n, a management server 108, storage devices 110, and a switch 112 in a server pod 114 where the datacenter 116 typically has numerous server pods 114 with various mixes of servers 106 and other computing devices. Typically, a server 106 includes one or more CPUs 120, one or more GPUs 122, memory 124, and other hardware devices typical of a server 106. In addition, the servers 106 include a BMC 126 where the system 100 includes a management network 134. Where the system 100 includes a management network 134, the storage devices 110, switch 112, and other equipment may also include a BMC 126. The management network 134 and associated management server(s) 108 and off-site management server 136 provide a portal into computing equipment of the system 100 to manage deployment operations, control fan speeds, monitor operations of the computing equipment, and the like. Typically, the management server 108 connects to the off-site management server 136 over a private management network 134. In other embodiments, the management server 108 connects to the off-site management server 136 through the main data network 130 over a secure connection, such as a virtual private network (“VPN”).

The datacenter 116 includes a connection to clients 132 over a main data network 130, which is a computer network. The clients 132 typically request execution of workloads associated with an application. In some embodiments, the servers 106 include virtual machines (“VMs”) or containers to provide privacy and security between clients 132. Operations to execute workloads for clients 132 are different than management operations through the BMC 126 as well as other management via the datacenter user interface 140.

The main data network 130 and/or the management network 134, in various embodiments, include a LAN, a WAN, a fiber network, a wireless connection, such as a cellular network, a Wi-Fi network, etc., and may include more than one type of network. Typically, switches 112 in the server pods 114 and other locations in the datacenter 116 connect to the main data network 130 to allow the clients 132 to connect to the servers 106 and other various computing devices of the datacenter 116.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

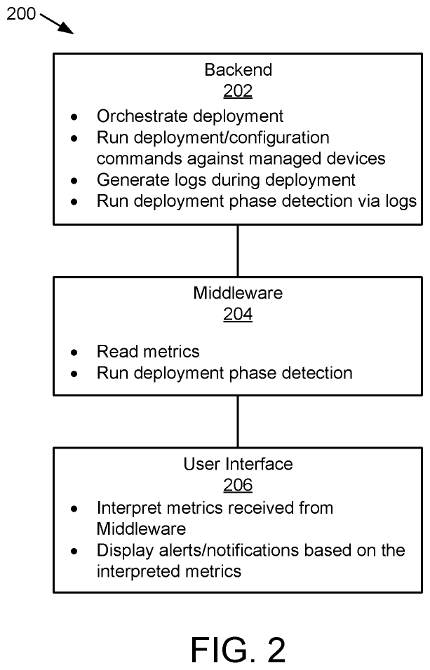

In some embodiments, the datacenter 116 includes one or more monitoring servers 104 that monitor various metrics, services, parameters, operations, measurements, and the like. In some embodiments, the monitoring servers 104 is located in a physical server in a server pod 114. In some embodiments, larger datacenters 116 include more than one monitoring server 104. In some embodiments, the one or more monitoring servers 104 run on a virtual machine (“VM”) operating on a physical server. In some embodiments, the one or more monitoring servers 104 run middleware (see middleware 204 of FIG. 2), which includes an application that monitors servers 106, switches 112, storage devices 110, and other equipment in a datacenter or other location. Typically, the middleware 204 is connected to a user interface, such as the datacenter user interface 140, a user interface of a local management server 108, or a user interface of an off-site management server 136. In some embodiments, the middleware 204 is separate from operations associated with processing of workloads for clients 132 and has enough connections to the operating systems, measurement hardware, etc. to monitor operations of the servers 106 and other equipment to report to the datacenter user interface 140.

While the system 100 is depicted as a datacenter 116, other systems with servers 106, storage devices 110, and the like may include middleware 204 running on one or more monitoring servers 104 where a backend 202 may initiate a deployment operation monitored by the middleware 204. In some examples, an edge network may include one or more servers 106 that are monitored by middleware 204 where a deployment operation may be initiated at the edge location. In various embodiments, a monitoring server 104 includes a deployment threshold apparatus 102 in an edge location or other location with servers and other computing equipment.

FIG. 2 is a schematic block diagram 200 illustrating interaction between a backend 202, middleware 204 and a user interface 206 for performance monitoring with context-aware dynamic threshold setting, according to various embodiments. In some embodiments, the backend 202 and middleware 204 are applications and/or software running on various components of the system 100. In some embodiments, the backend 202 is at least partially operating on a management network 134. In other embodiments, for example in a server without a management network 134 and a BMC 126 in servers 106 and other computing equipment, the backend 202 operates elsewhere in the system 100, such as on the monitoring server 104 or other server operated by a system administrator and used for deployment operations. In some embodiments, the backend 202 is partially executed through the management network 134 and is partially executed in other system software.

In some embodiments, the backend 202 orchestrates deployment operations, runs deployment and configuration commands against managed computing devices, such as the servers 106, storage devices 110, etc. In some embodiments, the deployment operation interrupts processing of the workloads for the one or more clients 132 on the computing device affected by the deployment operation. In some embodiments, the backend 202 generates logs during deployment useful in determining appropriate deployment thresholds for a deployment operation. In some embodiments, the backend 202 runs deployment phase detection via logs. For example, the backend 202 may determine if a deployment operation is still running or is terminated. In various embodiments, the backend 202 commences a deployment operation in response to a system administrator initiating the deployment operation to update an operating system or application, to install an application, or the like. In various embodiments, a deployment operation is a maintenance operation controlled separately from other operations to execute workloads. In other embodiments, the backend 202 initiates a deployment operation automatically in response to receiving a software update, crossing a threshold, or other trigger operation. In other embodiments, the backend 202 initiates a deployment operation in response to hardware changes. One of skill in the art will recognize other ways for the backend 202 to initiate and operate a deployment operation.

The middleware 204, in some embodiments, runs on a monitoring server 104. The middleware 204 typically is a monitoring and control system used to gather information about operation of the servers 106 and other computing equipment of the system 100. The middleware 204, in various embodiments, runs metrics, gathers data, reads metering hardware, and reports results to the user interface 206. In some embodiments, the middleware 204 interacts with the backend 202 and the user interface 206 to gather and pass on metrics, readings, alerts, and the like to the user interface 206 and/or the backend 202. In some embodiments, the middleware 204 interfaces with the servers 106 and other hardware but operates external to the servers 106 and other hardware.

In some embodiments, the middleware 204 runs a deployment operation phase detection to determine when a deployment operation begins and/or ends. In some examples, the middleware uses a representational state transfer (“REST”) application programming interface (“API”) to interact with the backend 202. The REST API conforms to design principles of the REST architectural style. REST APIs typically provide a flexible, lightweight way to integrate applications and to connect components in microservices architectures. In some embodiments, a REST API is used by the middleware 204 to interface with the backend 202 to determine when the deployment operation begins and ends.

The datacenter user interface 140 typically includes an electronic display, such as a computer monitor, as well as user input/output devices, such as a keyboard, a mouse, a stylus, a speaker, etc. The user interface 206, in some embodiments, includes applications and other software to interface with the electronic display and other user input/output devices. In some embodiments, the user interface 206 interprets metrics received from the middleware 204. In other embodiments, the user interface 206 displays alerts, notifications, etc. based on interpreted metrics. In other embodiments, the user interface 206 includes a graphical user interface (“GUI”) that includes system information, alerts, notifications, etc. In other embodiments, the user interface 206 presents analytics, alerts, notifications, metrics, etc. via the GUI. In other embodiments, the middleware 204 interprets metrics and other data and passes to the user interface 206 results for display. While the user interface 206 is depicted separately from the backend 202, in some embodiments, the backend 202 includes some or all of the elements of the user interface 206 and the middleware 204 sends metrics, results, alerts, notifications, etc. to the user interface of the backend 202. In other embodiments, the user interface 206 sends at least some results, metrics, alerts, notifications, etc. to the backend 202 for display and system administrator action.

Typically, the middleware 204 operates based on execution and processing of workloads in the servers 106 and other computing equipment of the system 100. The middleware 204 typically includes numerous thresholds to indicate problems, potential problems, issues, threats, etc. In some embodiments, the thresholds, which may be called operational thresholds, are geared towards completion of actions and the like. In some embodiments, the middleware 204 includes dynamic operational thresholds that adjust over time based operation of the servers 106, applications, processes, etc. In some embodiments, some operational thresholds operate within hardware of the servers 106 and other computing devices of the system 100 and report instances of operational threshold violations to the middleware 204.

When a deployment operation begins, many of the operational thresholds in the middleware 204, are in some way not applicable. In addition, due to the start of a deployment operation being abrupt, dynamic notifications may not have time to adjust. In addition, the deployment operation may include one or more deployment thresholds specifically applicable to the deployment operation. The deployment thresholds, in some embodiments, override operational thresholds. In other embodiments, the operational thresholds are inapplicable and may need to be deactivated. In other embodiments, operational thresholds are altered during a deployment operation. Upon completion of the deployment operation, the deployment thresholds are typically deactivated while the operational thresholds are restored for normal workload processing.

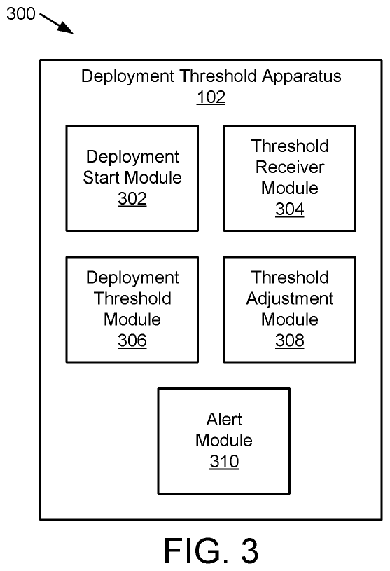

FIG. 3 is a schematic block diagram illustrating an apparatus 300 for performance monitoring with context-aware dynamic threshold setting, according to various embodiments. The apparatus 300 includes a deployment threshold apparatus 102 that includes a deployment start module 302, a threshold receiver module 304, a deployment threshold module 306, a threshold adjustment module 308, and an alert module 310, which are described below. In some embodiments, the apparatus 300 and associated modules 302-310 are implemented using executable code stored on computer readable storage media, which is non-transitory. In other embodiments, some or all of the apparatus 300 is implemented using a programmable hardware device and/or hardware circuits.

The apparatus 300 includes a deployment start module 302 configured to determine initiation of a deployment operation for a computing device, such as a server 106, a storage device 110, a switch 112, or the like. The deployment operation differs from operations that include processing, on the computing device, workloads for one or more clients 132. The deployment operations, in various embodiments, include an operation to install, update, configure, commission, and/or remove an operating system, an application, and/or firmware. Typically, the deployment operation is initiated by a backend 202, such as through a management server 108 which interacts with one or more BMCs 126 to initiate the deployment operation. In other embodiments, the datacenter user interface 140 is used to interact with the backend 202 to initiate the deployment operation.

In some embodiments, the deployment start module 302 determines initiation of the deployment operation by the backend 202. In some instances, the backend 202 is unaware of operations of the middleware 204 so that the deployment start module 302, through the middleware 204, monitors the backend 202 and detects start of the deployment operation. In other embodiments, the backend 202 pushes a notification of the start of the deployment operation to the deployment start module 302 which uses the notification to determine initiation of the deployment operation.

The apparatus 300 includes a threshold receiver module 304 configured to receive one or more deployment thresholds associated with the deployment operation. The one or more deployment thresholds, in some embodiments, override one or more operational thresholds. In other embodiments, the deployment thresholds are separate from the operational thresholds. In other embodiments, the deployment thresholds are for different metrics, processes, etc. than the operational thresholds, but require suspension of affected operational thresholds. In some embodiments, some operational thresholds are safety thresholds and remain in place during the deployment operation. For example, a safety threshold may include a temperature upper limit and is configured within the servers 106 or other hardware of the system 100 to operate regardless of the deployment operation, workload execution, etc. One of skill in the art will recognize how the one or more deployment thresholds interact with the operational thresholds.

The apparatus 300 includes a deployment threshold module 306 configured to implement the one or more deployment thresholds and a threshold adjustment module 308 configured to adjust one or more operational thresholds conflicting with the deployment operation. In some embodiments, the deployment threshold module 306 and the threshold adjustment module 308 operate together to determine, based on the received deployment thresholds, which operational thresholds are to be suspended, adjusted, left operational, or the like. In some embodiments, the threshold adjustment module 308 determines when a received deployment threshold affects one or more operational thresholds and determines an action to be taken on the operational thresholds. The actions to be taken may include suspension of the operational thresholds, changing of the operational thresholds, etc. In some embodiments, the threshold adjustment module 308 determines that the received deployment thresholds do not affect a subset of operational thresholds, which are then not affected.

The apparatus 300 includes an alert module 310 configured to transmit an alert in response to detection of a metric associated with a deployment threshold of the one or more deployment thresholds exceeding the deployment threshold. In other embodiments, the alert module 310 or other portions of the middleware 204 monitor metrics associated with other operational thresholds that continue to operate during the deployment operation and send alerts for violations of the operational threshold. In some embodiments, the alert module 310 transmits alerts to the user interface 206 for display on a GUI or transmission of a sound to a speaker of the datacenter user interface 140 and/or a user interface of the management network 134. In some embodiments, the alert module 310 transmits the alert to a user interface of a datacenter monitoring system (e.g., datacenter user interface 140) and/or a management server 108 connected to a management network 134.

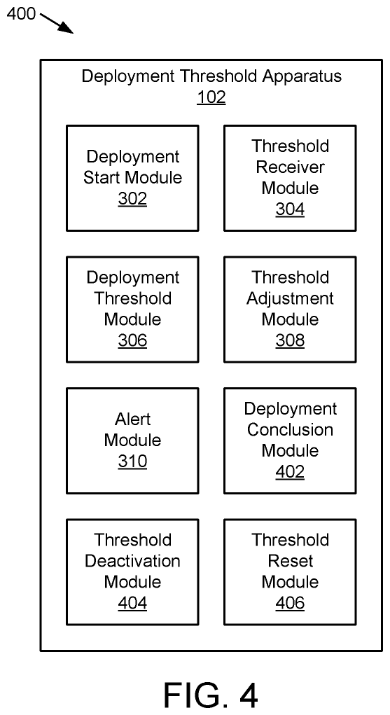

FIG. 4 is a schematic block diagram illustrating another apparatus 400 for performance monitoring with context-aware dynamic threshold setting, according to various embodiments. The apparatus 400 includes another deployment threshold apparatus 102 with a deployment start module 302, a threshold receiver module 304, a deployment threshold module 306, a threshold adjustment module 308, and an alert module 310, which are substantially similar to those described above in relation to the apparatus 300 of FIG. 3. In various embodiments, the deployment threshold apparatus 102 includes a deployment conclusion module 402, a threshold deactivation module 404, and/or a threshold reset module 406, which are described below. In various embodiments, the apparatus 400 is implemented similar to implementation of the apparatus 300 of FIG. 3.

In some embodiments, the apparatus 400 includes a deployment conclusion module 402 configured to determine that the deployment operation has concluded. In some embodiments, the deployment conclusion module 402 detects that the deployment operation has concluded. In other embodiments, the backend 202 transmits a notification that the deployment operation has concluded and the deployment conclusion module 402 receives the notification of conclusion of the deployment operation.

In some embodiments, the apparatus 400 includes a threshold deactivation module 404 configured to deactivate the one or more deployment thresholds in response to the deployment operation being concluded and/or a threshold reset module 406 configured to reactivate the one or more operational thresholds altered during the deployment operation. In some embodiments, the threshold deactivation module 404 and the threshold reset module 406 work together to both deactivate the deployment thresholds and to reset the operational thresholds after completion of the deployment operation. For example, an operational threshold and a deployment threshold may be for a same metric and may have been set to a different level by the deployment threshold so that the threshold deactivation module 404 and the threshold reset module 406 work together to set the operational threshold back to a level prior to the deployment operation. In some embodiments, the threshold deactivation module 404 deactivates the deployment thresholds and the threshold reset module 406 resets operational thresholds that were suspended, adjusted, overridden, etc. back to a state before the deployment operation.

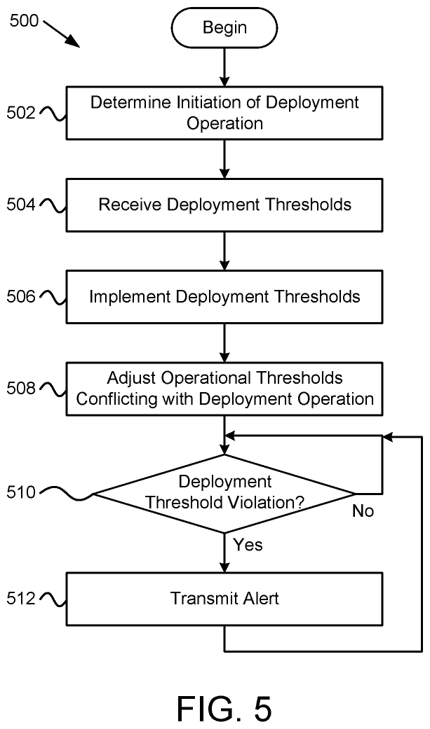

FIG. 5 is a schematic flow chart diagram illustrating a method 500 for performance monitoring with context-aware dynamic threshold setting, according to various embodiments. The method 500 begins and determines 502 initiation of a deployment operation for a computing device, such as a server 106, storage device 110, etc. The deployment operation differs from operations that include processing, on the computing device, workloads for one or more clients 132. The method 500 receives 504 one or more deployment thresholds associated with the deployment operation and implements 506 the one or more deployment thresholds. The method 500 adjusts 508 one or more operational thresholds conflicting with the deployment operation.

The method 500 determines 510 if a metric associated with a deployment threshold has been exceeded. If the method 500 determines 510 that a metric associated with a deployment threshold has been exceeded, the method 500 transmits 512 an alert, and the method 500 returns and continues to determine 510 if a metric associated with the deployment threshold has been exceeded. If the method 500 determines 510 that that a metric associated with a deployment threshold has not been exceeded, the method 500 returns and continues to determine 510 if a metric associated with the deployment threshold has been exceeded. In various embodiments, all or a portion of the method 500 is implemented using the deployment start module 302, the threshold receiver module 304, the deployment threshold module 306, the threshold adjustment module 308, and/or the alert module 310.

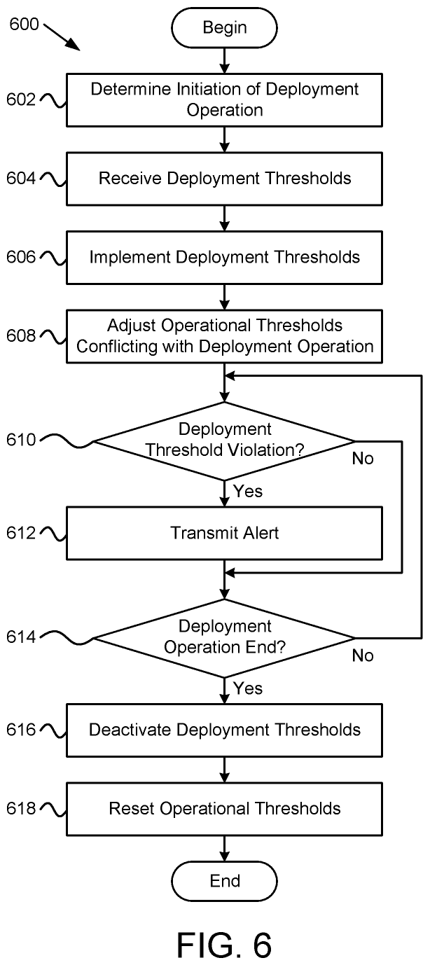

FIG. 6 is a schematic flow chart diagram illustrating another method 600 for performance monitoring with context-aware dynamic threshold setting, according to various embodiments. The method 600 begins and determines 602 initiation of a deployment operation for a computing device, such as a server 106, storage device 110, etc. The deployment operation differs from operations that include processing, on the computing device, workloads for one or more clients 132. The method 600 receives 604 one or more deployment thresholds associated with the deployment operation and implements 606 the one or more deployment thresholds. The method 600 adjusts 608 one or more operational thresholds conflicting with the deployment operation.

The method 600 determines 610 if a metric associated with a deployment threshold has been exceeded. If the method 600 determines 610 that a metric associated with a deployment threshold has been exceeded, the method 600 transmits 612 an alert and determines 614 if the deployment operation has ended. If the method 600 determines 610 that that a metric associated with a deployment threshold has not been exceeded, the method 600 determines 614 if the deployment operation has ended.

If the method 600 determines 614 that the deployment operation has not ended, the method 600 returns and continues to determine 610 if a metric associated with the deployment threshold has been exceeded. If the method 600 determines 614 that the deployment operation has ended, the method 600 deactivates 616 the deployment thresholds and resets 618 the operational thresholds altered during the deployment operation, and the method 600 ends. In various embodiments, all or a portion of the method 500 is implemented using the deployment start module 302, the threshold receiver module 304, the deployment threshold module 306, the threshold adjustment module 308, the alert module 310, the deployment conclusion module 402, the threshold deactivation module 404, and/or the threshold reset module 406.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
determining initiation of a deployment operation for a computing device, wherein the deployment operation differs from operations comprising processing, on the computing device, workloads for one or more clients;
receiving one or more deployment thresholds associated with the deployment operation;
implementing the one or more deployment thresholds;
adjusting one or more operational thresholds conflicting with the deployment operation; and
transmitting an alert in response to detection of a metric associated with a deployment threshold of the one or more deployment thresholds exceeding the deployment threshold.

2. The method of claim 1, further comprising:
determining that the deployment operation has concluded;
deactivating the one or more deployment thresholds in response to the deployment operation being concluded; and
resetting the one or more operational thresholds altered during the deployment operation.

3. The method of claim 2, wherein determining that the deployment operation has concluded comprises one of detecting that the deployment operation has concluded and receiving a notification that the deployment operation has concluded.

4. The method of claim 1, wherein the deployment operation is initiated through a management network separate from a computer network servicing execution of the workloads for the one or more clients.

5. The method of claim 1, wherein the alert is transmitted to a user interface of a datacenter monitoring system and/or a management server connected to a management network.

6. The method of claim 1, wherein the deployment operation is initiated via a management network.

7. The method of claim 1, wherein the deployment operation interrupts processing of the workloads for the one or more clients on the computing device.

8. The method of claim 1, wherein determining the initiation of the deployment operation for the computing device comprises one of:
detecting the initiation of the deployment operation; and
receiving a notification of the initiation of the deployment operation.

9. The method of claim 1, wherein the deployment operation comprises an operation to install, update, configure, commission, and/or remove an operating system, an application, and/or firmware.

10. An apparatus comprising:
a processor; and
non-transitory computer readable storage media storing code, the code being executable by the processor to perform operations comprising:
determining initiation of a deployment operation for a computing device, wherein the deployment operation differs from operations comprising processing, on the computing device, workloads for one or more clients;
receiving one or more deployment thresholds associated with the deployment operation;
implementing the one or more deployment thresholds;
adjusting one or more operational thresholds conflicting with the deployment operation; and
transmitting an alert in response to detection of a metric associated with a deployment threshold of the one or more deployment thresholds exceeding the deployment threshold.

11. The apparatus of claim 10, the operations further comprising:
determining that the deployment operation has concluded;
deactivating the one or more deployment thresholds in response to the deployment operation being concluded; and
resetting the one or more operational thresholds altered during the deployment operation.

12. The apparatus of claim 11, wherein determining that the deployment operation has concluded comprises one of detecting that the deployment operation has concluded and receiving a notification that the deployment operation has concluded.

13. The apparatus of claim 10, wherein the deployment operation is initiated through a management network separate from a computer network servicing execution of the workloads for the one or more clients.

14. The apparatus of claim 10, wherein the alert is transmitted to a user interface of a datacenter monitoring system and/or a management server connected to a management network.

15. The apparatus of claim 10, wherein the deployment operation is initiated via a management network.

16. The apparatus of claim 10, wherein the deployment operation interrupts processing of the workloads for the one or more clients on the computing device.

17. The apparatus of claim 10, wherein determining the initiation of the deployment operation for the computing device comprises one of:
detecting the initiation of the deployment operation; and
receiving a notification of the initiation of the deployment operation.

18. The apparatus of claim 10, wherein the deployment operation comprises an operation to install, update, configure, commission, and/or remove an operating system, an application, and/or firmware.

19. A program product comprising a non-transitory computer readable storage medium storing code, the code being configured to be executable by a processor to perform operations comprising:
determining initiation of a deployment operation for a computing device, wherein the deployment operation differs from operations comprising processing, on the computing device, workloads for one or more clients;
receiving one or more deployment thresholds associated with the deployment operation;
implementing the one or more deployment thresholds;
adjusting one or more operational thresholds conflicting with the deployment operation; and
transmitting an alert in response to detection of a metric associated with a deployment threshold of the one or more deployment thresholds exceeding the deployment threshold.

20. The program product of claim 19, the operations further comprising:
determining that the deployment operation has concluded;
deactivating the one or more deployment thresholds in response to the deployment operation being concluded; and
resetting the one or more operational thresholds altered during the deployment operation.
